(19) United States
(12) Patent Application Publication
(10) Pub. No.: US 2026/0228921 A1
(43) Pub. Date: Aug. 6, 2026

(54) Method of Image Processing

(71) Applicant: Lumirithmic Limited, Winchester (GB)

(72) Inventors: Xiaohui LI, London (GB); Giuseppe Claudio GUARNERA, York (GB); Abhijeet GHOSH, Orpington (GB); Gaurav Chawla, Shenfield (GB); Gilles Rainer, London (GB); Lewis Bridgeman, Guildford, Surrey (GB)

(73) Assignee: Lumirithmic Limited, Winchester (GB)

(21) Appl. No.: 19/042,912

(22) Filed: Jan. 31, 2025

(51) Int. Cl. G06T 7/90

(52) U.S. Cl. CPC G06T 7/90; G06T 2207/10024; G06T 2207/10152; G06T 2207/20081; G06T 2207/20084; G06T 2207/30088

(57) ABSTRACT

A method of image processing is disclosed. The method comprises receiving inputs comprising a first RGB image of human skin, the first image corresponding to a first, visible spectrum broadband illumination condition. The method further comprises processing the inputs to fit parameter maps for a hyperspectral bidirectional scattering surface reflectance distribution function skin appearance model, the parameter maps comprising a melanin concentration, a melanin blend-type fraction, a dermal haemoglobin concentration, an epidermal haemoglobin concentration and a beta-carotene concentration, wherein at least four of the parameter maps are independent.

### FIELD

The present invention relates to a method of processing images of human skin.

### BACKGROUND

Accurate facial appearance modelling has been a topic of extensive research in computer graphics and vision. Several biophysically-based spectral skin reflectance models have been proposed in recent years [2, 7, 10-12, 17, 18]. Previous works have either proposed complex biophysical models with a large number of parameters to represent various chromophores in the human skin [7, 11, 18], or employed simpler models with fewer parameters that can be practically measured [12, 17], albeit with reduced model accuracy. Most of these works have mainly focused on the visible domain, in which some facial features that are crucial for skin appearance and protection might be concealed [7].

Previous works estimate spectral skin parameters to achieve high-quality appearance reconstructions by searching in a LookUp Table (LUT) of pre-computed skin tones the closest RGB values of facial albedo images, on a pixel by pixel basis [12, 17]. Such approach is a computationally expensive, particularly for models with higher complexity.

### REFERENCES

[1] 2022. Facial Skin Aging: an overview of biological aging processes. International Journal of Cosmetic Science (15 Apr. 2022). https://doi.org/10.1111/ics.12779
[2] Carlos Aliaga, Christophe Hery, and Mengqi Xia. 2022. Estimation of Spectral Biophysical Skin Properties from Captured RGB Albedo. ArXiv abs/2201.10695 (2022).
[3] R. Rox Anderson and John A. Parrish. 1981. The Optics of Human Skin. Journal of Investigative Dermatology 77, 1 (1981), 13-19. https://doi.org/10.1111/1523-1747.ep12479191
[4] Michael Attas, Trevor Posthumus, Bernie Schattka, Michael Sowa, Henry Mantsch, and Shuliang Zhang. 2002. Long-wavelength near-infrared spectroscopic imaging for in-vivo skin hydration measurements. Vibrational Spectroscopy 28, 1 (2002), 37-43. https://doi.org/10.1016/S0924-2031(01)00143-6 A Collection of Papers Presented at SHEDDING NEW LIGHT ON DISEASE: Optical Diagnostics for the New Millennium, Winnipeg, Canada, Jun. 25-30, 2000.
[5] Laurence Boissieux, Gergo Kiss, Nadia Thalmann, and Prem Kalra. 2000. Simulation of Skin Aging and Wrinkles with Cosmetics Insight. Computer Animation and Simulation (January 2000). https://doi.org/10.1007/978-3-7091-6344-3_2
[6] Zakharov P Caduff A, Talary M S. 2010. Cutaneous blood perfusion as a perturbing factor for noninvasive glucose monitoring. Diabetes Technology Therapeutics 12(1) (2010). https://doi.org/10.1089
[7] Tenn F. Chen, Gladimir V. G. Baranoski, Bradley W. Kimmel, and Erik Miranda. 2015. Hyperspectral Modeling of Skin Appearance. ACM Trans. Graph. 34, 3, Article 31 (May 2015), 14 pages. https://doi.org/10.1145/2701416
[8] Symon Cotton, Ela Claridge, and Per Hall. 1999. A skin imaging method based on a colour formation model and its application to the diagnosis of pigmented skin lesions. Proceedings of Medical Image Understanding and Analysis 99 (January 1999), 49-52.
[9] Craig Donner and Henrik Wann Jensen. 2005. Light Diffusion in Multi-Layered Translucent Materials. (2005), 1032-1039. https://doi.org/10.1145/1186822. 1073308
[10] Craig Donner and Henrik Wann Jensen. 2006. A spectral shading model for human skin. ACM SIGGRAPH 2006: Sketches, SIGGRAPH '06 5 (2006), 5. https://doi.org/10.1145/1179849.1180033
[11] Craig Donner, Tim Weyrich, Eugene D′eon, Ravi Ramamoorthi, and Szymon Rusinkiewicz. 2008. A layered, heterogeneous reflectance model for acquiring and rendering human skin. ACM SIGGRAPH Asia 2008 Papers, SIGGRAPH Asia′08 Section 5 (2008). https://doi.org/10.1145/1457515.1409093
[12] WO 2022/003308 A1 which is which is incorporated herein by reference in its entirety.
[13] Giuseppe Claudio Guarnera, Yuliya Gitlina, Valentin Deschaintre, and Abhijeet Ghosh. 2022. Spectral Upsampling Approaches for RGB Illumination. In Eurographics Symposium on Rendering, Abhijeet Ghosh and Li-Yi Wei (Eds.). The Eurographics Association. https://doi.org/10.2312/sr.20221150
[14] H. Hotelling. 1933. Analysis of a complex of statistical variables into principal components. The Journal of Educational Psychology 24 (1933), 417-441. https://doi.org/10.1037/h0071325
[15] Jose A. Iglesias-Guitian, Carlos Aliaga, Adrian Jarabo, and Diego Gutierrez. 2015. A Biophysically-Based Model of the Optical Properties of Skin Aging. Computer Graphics Forum (EUROGRAPHICS 2015) 34, 2 (2015).
[16] H W. Jensen, S. R. Marschner, M. Levoy, and P. Hanrahan. 2001. A practical model for subsurface light transport. Proceedings of the ACM SIGGRAPH Conference on Computer Graphics (2001), 511-518. https://doi.org/10.1145/383259.383319
[17] Jorge Jimenez, Timothy Scully, Nuno Barbosa, Craig Donner, Xenxo Alvarez, Teresa Vieira, Paul Matts, Verónica Orvalho, Diego Gutierrez, and Tim Weyrich. 2010. A practical appearance model for dynamic facial color. ACM Transactions on Graphics 29, 6 (2010), 1-10. https://doi.org/10.1145/1866158.1866167
[18] Aravind Krishnaswamy and Gladimir V. G. Baranoski. 2004. A biophysically-based spectral model of light interaction with human skin. Computer Graphics Forum 23, 3 (2004), 331-340. https://doi.org/10.1111/j.1467-8659.2004.00764.x
[19] S. J. Preece and E. Claridge. 2004. Spectral filter optimization for the recovery of parameters which describe human skin. IEEE Transactions on Pattern Analysis and Machine Intelligence 26, 7 (2004), 913-922. https://doi.org/10.1109/TPAMI.2004.36

### SUMMARY

According to a first aspect of the invention, there is provided a method of image processing, the method comprising receiving inputs comprising a first RGB image of human skin, the first image corresponding to a first, visible spectrum broadband illumination condition. The method further comprises processing the inputs to fit parameter maps for a hyperspectral bidirectional scattering surface reflectance distribution function skin appearance model, the parameter maps comprising a melanin concentration, a melanin blend-type fraction, a dermal haemoglobin concentration, an epidermal haemoglobin concentration and a beta-carotene concentration, wherein at least four of the parameter maps are independent.

Receiving the first image may comprise correcting a colour balance of the first image in dependence upon spectral data corresponding to the first illumination condition. The spectral data may be received along with the first image. The spectral data may be determined based on a further image of a standard colour chart imaged under the first illumination condition. The spectral data may be measured, for example, using a benchtop spectrometer. In some examples, the first image may be corrected for colour balance prior to reception. Once corrected based on the spectral data, the first image may take the form of white albedo data. In some illumination conditions, colour balance correction may not be required, for example, where illumination conditions are consistent or constant.

The hyperspectral model may range from ultraviolet A (UVA) to near infrared (NIR) spectral bands, i.e. the model may span the UVA-visible-NIR range of spectral bands.

The epidermal haemoglobin concentration may be computed as a scaled version of the dermal haemoglobin concentration.

The inputs may further comprise a second RGB or greyscale image which has the same field of view and contents as the first image, the second image corresponding to a second visible spectrum illumination condition which comprises a first narrowband illumination condition.

The second image may be an image corresponding to a first narrowband illumination condition generated using a first colour channel of the first image.

The first narrowband illumination condition may be in the blue light range, for example, light between around 450 and 495 nanometres. The second visible spectrum illumination condition may comprise a broadband illumination condition. The second image may be generated using a first colour channel of the first image or by calculating a synthetic image based on the first image.

Receiving the second image may comprise correcting a colour balance of the second image in dependence upon spectral data corresponding to the second visible spectrum illumination condition. The spectral data may be received along with the second image. The spectral data may be determined based on a further image of a standard colour chart imaged under the second illumination condition. The spectral data may be measured, for example, using a benchtop spectrometer. In some examples, the second image may be corrected for colour balance prior to reception. Once corrected based on the spectral data, the second image may take the form of multispectral albedo data. In some illumination conditions, colour balance correction may not be required, for example, where illumination conditions are consistent or constant.

The inputs may further comprise a third RGB or greyscale image which has the same field of view and contents as the first image, the third image corresponding to a third visible spectrum illumination condition which comprises a second narrowband illumination condition.

The third image may be an image corresponding to a second narrowband illumination condition generated using a second colour channel of the first image.

The second narrowband illumination condition may be in the green light range, for example, light between around 500 and 565 nanometres. The third visible spectrum illumination condition may comprise a broadband illumination condition. The second image may be generated using a second colour channel of the first image or by calculating a synthetic image based on the first image.

Receiving the third image may comprise correcting a colour balance of the third image in dependence upon spectral data corresponding to the third visible spectrum illumination condition. The spectral data may be received along with the third image. The spectral data may be determined based on a further image of a standard colour chart imaged under the third illumination condition. The spectral data may be measured, for example, using a benchtop spectrometer. In some examples, the third image may be corrected for colour balance prior to reception. Once corrected based on the spectral data, the third image may take the form of multispectral albedo data. In some illumination conditions, colour balance correction may not be required, for example, where illumination conditions are consistent or constant.

The inputs may further comprise a fourth image corresponding to a fourth visible spectrum narrowband illumination condition generated using a first colour channel of the first image.

The third narrowband illumination condition may be similar to the first narrowband illumination condition. For example, the first and third narrowband illumination conditions may have similar or overlapping ranges. For example, the third image may be generated from using the blue colour channel of the first image.

The inputs may further comprise a fifth image corresponding to a fifth visible spectrum narrowband illumination condition generated using a second colour channel of the first image.

The fourth narrowband illumination condition may be similar to the second narrowband illumination condition. For example, the second and fourth narrowband illumination conditions may have similar or overlapping ranges. For example, the fourth image may be generated from using the green colour channel of the first image.

Processing the inputs to fit the parameter maps may comprise receiving a first five-dimensional look up table corresponding to the first illumination condition, the first look-up table comprising RGB values as a function of the melanin concentration, the melanin blend-type fraction, the dermal haemoglobin concentration, the epidermal haemoglobin concentration and the beta-carotene concentration, for each pixel of the first image: determining a melanin concentration, the melanin blend-type fraction, the dermal haemoglobin concentration, the epidermal haemoglobin concentration and the beta-carotene concentration that minimise a distance metric in colour space between the corresponding look up table value and the pixel of the first image.

Determining the melanin concentration, the melanin blend-type fraction, the dermal haemoglobin concentration, the epidermal haemoglobin concentration and the beta-carotene concentration for each pixel may comprise: for a first beta-carotene concentration equal to a pre-determined value, determining a first melanin concentration and a first melanin blend-type fraction that minimise a distance metric in colour space between the corresponding look up table value and the pixel of the first image; and for the first melanin concentration and first melanin blend-type fraction equal to the determined values, determining a first dermal haemoglobin concentration, first epidermal haemoglobin concentration, and second beta-carotene concentration that minimise a distance metric in colour space between the corresponding look up table value and the pixel of the first image.

Receiving the five-dimensional first look up table may comprise retrieving from memory.

Processing the inputs to fit the parameter maps may comprise receiving a first five-dimensional look up table corresponding to the first visible spectrum illumination condition comprising RGB values as a function of the melanin concentration, the melanin blend-type fraction, the dermal haemoglobin concentration, the epidermal haemoglobin concentration and the beta-carotene concentration, receiving, a second five-dimensional look up table corresponding to receiving a first five-dimensional look up tables corresponding to the first visible spectrum illumination condition comprising RGB values as a function of the melanin concentration, the melanin blend-type fraction, the dermal haemoglobin concentration, the epidermal haemoglobin concentration and the beta-carotene concentration, for each pixel of the first image and the second or fourth image: for a first beta-carotene concentration equal to a pre-determined value for the first and second look up tables, determining a first melanin concentration and a first melanin blend-type fraction based on respective melanin concentrations and melanin blend-type fractions that minimise a distance metric in colour space between the corresponding look up table values and the pixels of the first and second or fourth image; and for the melanin concentration and melanin blend-type fraction equal to the first melanin concentration and first melanin blend-type fraction, determining a second beta-carotene concentration based on respective beta-carotene concentrations that minimise a distance metric in colour space between the corresponding look up table values and the pixels of the first and second or fourth image.

Processing the inputs to fit the parameter maps may comprise for each pixel of the first image and the second or fourth image: for the second beta-carotene concentration, the first melanin concentration and first melanin blend-type fraction, determining a first dermal haemoglobin concentration, and first epidermal haemoglobin concentration based on respective dermal haemoglobin concentrations, and epidermal haemoglobin concentrations that minimise a distance metric in colour space between the corresponding look up table values and the pixels of the first and second or fourth image.

Processing the inputs to fit the parameter maps may comprise receiving a first five-dimensional look up table corresponding to the first visible spectrum illumination condition comprising RGB values as a function of the melanin concentration, the melanin blend-type fraction, the dermal haemoglobin concentration, the epidermal haemoglobin concentration and the beta-carotene concentration, receiving, a second five-dimensional look up table corresponding to the second or fourth visible spectrum illumination conditions, each look-up table comprising RGB values or greyscale values as a function of the melanin concentration, the melanin blend-type fraction, the dermal haemoglobin concentration, the epidermal haemoglobin concentration and the beta-carotene concentration, receiving a third five-dimensional look up table corresponding to the third or fifth visible spectrum illumination conditions, each look-up table comprising RGB values or greyscale values as a function of the melanin concentration, the melanin blend-type fraction, the dermal haemoglobin concentration, the epidermal haemoglobin concentration and the beta-carotene concentration, for each pixel of the first image and either second or fourth images: for a first beta-carotene concentration equal to a pre-determined value for the first and second look up tables, determining a first melanin concentration and a first melanin blend-type fraction based on respective melanin concentrations and melanin blend-type fractions that minimise a distance metric in colour space between the corresponding look up table values and the pixels of the first and second or fourth image; and for the melanin concentration and melanin blend-type fraction equal to the first melanin concentration and first melanin blend-type fraction, determining a second beta-carotene concentration based on respective beta-carotene concentrations that minimise a distance metric in colour space between the corresponding look up table values and the pixels of the first and second or fourth image; and for each pixel of the first and either third or fifth images: for the second beta-carotene concentration, the first melanin concentration and first melanin blend-type fraction, determining a first dermal haemoglobin concentration, and first epidermal haemoglobin concentration based on respective dermal haemoglobin concentrations, and epidermal haemoglobin concentrations that minimise a distance metric in colour space between the corresponding look up table values and the pixels of the first and third or fifth image.

The inputs may further comprise a sixth RGB or greyscale image which has the same field of view and contents as the first image, the sixth image corresponding to a sixth visible spectrum illumination condition which comprises a fifth narrowband illumination condition. The method may further comprise: receiving a seven-dimensional look up table corresponding to narrowband red illumination comprising RGB values or greyscale values as a function of the melanin concentration, the melanin blend-type fraction, the dermal haemoglobin concentration, the epidermal haemoglobin concentration, the beta-carotene concentration, the epidermal water concentration and the dermal water concentration; using the estimated parameters for the melanin concentration, the melanin blend-type fraction, the dermal haemoglobin concentration, the epidermal haemoglobin concentration and the beta-carotene concentration; and for each pixel of the sixth image, determining an epidermal water concentration and a dermal water concentration that minimise a distance metric in colour space between the corresponding look up table values and the pixels of the sixth image.

The sixth image may be either: acquired under narrowband red illumination; or corresponding to the red channel of the first image.

The epidermal water concentration may be a scalar of the dermal water concentration.

Determining the epidermal water concentration and the dermal water concentration may comprise: for a first dermal water concentration, determining the epidermal water concentration; and using the determined epidermal water concentration, estimating a second dermal water concentration.

Determining the first melanin concentration, the first melanin blend-type fraction, or the second beta-carotene concentration may be based on respectively determining a melanin concentration, a melanin blend-type fraction, or a beta-carotene concentration for each of the first and second or fourth images and their corresponding look up tables and calculating a weighted average from the melanin concentrations, melanin blend-type fractions, or beta-carotene concentrations from the determined values from each image.

Determining a first dermal haemoglobin concentration or first epidermal haemoglobin concentration may be based on respectively determining a dermal haemoglobin concentration or epidermal haemoglobin concentration for each of the first and third or fifth images and their corresponding look up tables and calculating a weighted average from the dermal haemoglobin concentrations or epidermal haemoglobin concentrations from the determined values from each image.

Processing the inputs to fit the parameter maps may comprise: mapping the first image to the model parameters using a first neural network.

Processing the inputs to fit the parameter maps may comprise: mapping the first image and any one or more of the first to fifth images to the model parameters using a first neural network.

Any suitable combination of the first to fifth images may be used to calculate the hyperspectral model parameters.

The first neural network may be trained on RGB values of the parameter maps, and wherein the ground truth is the corresponding melanin concentration, a melanin blend-type fraction, a dermal haemoglobin concentration, an epidermal haemoglobin concentration and a beta-carotene concentration parameters.

The melanin blend-type fraction may be a blend between eumelanin and pheomelanin.

The distance metric is L2 distance in CIELAB colour space. The distance metric is ΔE₇₆ colour distance.

The broadband and/or narrowband illumination conditions may be uniform.

The beta-carotene concentration reference value may be derived from a training dataset containing photographs of different human skin types.

The beta-carotene concentration may be a mode of the distribution of the estimated beta-carotene values of the training dataset.

The first, second or third RGB or greyscale image of human skin may be obtained using one or more displays, light emitting diode arrays, or light emitting diode panels to illuminate the human skin.

There may be a plurality of displays, light emitting diode arrays, or light emitting diode panels and one or more cameras arranged between the displays light emitting diode arrays, or light emitting diode panels to capture the first, second, or third image. The second or third images may be obtained by using a display. The display, light emitting diode arrays, or light emitting diode panels may be any suitable display, light emitting diode arrays, or light emitting diode panels for example, a liquid crystal display, a light emitting diode display, an organic light emitting diode display, a plasma display. The display may be the display of a tablet or a computer screen.

According to a second aspect of the invention, there is provided a method of obtaining images for fitting a model, comprising capturing a first RGB image of human skin using a visible spectrum broadband illumination condition, a second RGB image using a visible spectrum broadband illumination condition and an illumination condition between 450 and 495 nanometres, and capturing a third RGB image of human skin using a visible spectrum broadband illumination condition and an illumination condition between 500 and 565 nanometres.

According to a third aspect of the invention, there is provided a method of estimating spectral response functions for human skin, comprising: receiving parameter maps for a hyperspectral bidirectional scattering surface reflectance distribution function skin appearance model, the parameter maps comprising a melanin concentration, a melanin blend-type fraction, a dermal haemoglobin concentration, an epidermal haemoglobin concentration and a beta-carotene concentration; for each pixel of the parameter maps, using the parameter map values to estimate a skin spectral response function for a wavelength range spanning from near infrared to ultraviolet; and storing and/or outputting the skin spectral response functions estimated for each pixel.

Each skin spectral response function may be calculated for each of a plurality of evenly spaced wavelengths spanning the range.

The wavelength spacing may be 2 nm.

Each skin spectral response function may be expressed as a closed function of the absorbances of the parameters.

Each skin spectral response function may be calculated using principal components of hyperspectral skin reflectance data.

There may be ten principal components.

The principal components may be calculated by applying a principal components analysis to a training set of hyperspectral skin reflectance data.

The hyperspectral skin reflectance data may span the hyperspectral skin appearance model.

Each skin spectral response function may be determined using a neural network trained on a principal component representation where the ground truth is the skin spectral response represented in terms of principal components, wherein the network maps input parameters comprising melanin concentration, a melanin blend-type fraction, a dermal haemoglobin concentration, an epidermal haemoglobin concentration and a beta-carotene concentration to a principal component representation of skin spectral response.

The method may comprise calculating the parameter maps according to the first aspect.

The method may further comprise rendering an output image using the spectral response functions.

The wavelength range may be between 300 nm to 1000 nm.

The wavelength range may be sampled in 2 nm increments.

### BRIEF DESCRIPTION OF THE DRAWINGS

Certain embodiments of the present invention will now be described, by way of example, with reference to the accompanying drawings, in which:

FIG. 1 are reconstructions of acquired faces of subject 1 (Mediterranean skin type, top row) and subject 2 (Caucasian skin type, bottom row) under uniform white illumination (a), estimated skin chromophore maps (b-f), and predicted UVA and NIR responses (g, h) using our proposed practical spectral measurement and modeling approach;

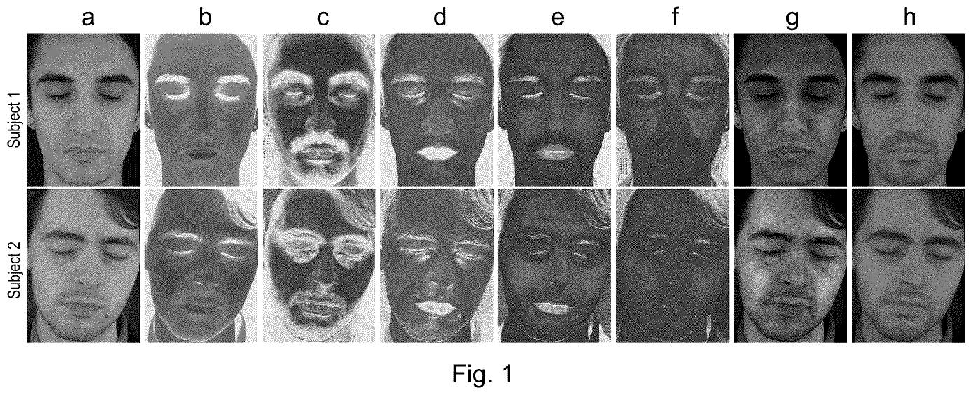

FIG. 2 are spectral skin reflectance model variation due to the parameter C_{bc}. For each patch, βₘ=0.5, Cₕₑ=0.25, x-axis shows the variation of Cₘ while y-axis shows the variation of C_{hd};

FIG. 3 is the spectral absorption coefficients curves for the skin chromophores included in our model, from 300 nm to 1000 nm. The spectral data is taken from Chen et al. [7], scaling each absorption coefficient to align with the model of Donner et al. [10, 11];

FIG. 4 is the spectra of white illumination for the monitor setup;

FIG. 5 are practical measurement spectral measurements of skin reflectance. (a) White (b) Synthetic blue (c) Synthetic green;

FIG. 6 are comparison of photos (a) and reconstructions (b) and estimated spectral parameters (c-g) for faces of Subject 1 (Caucasian skin type) and Subject 2 (South Asia skin type). The estimated chromophore parameters also predict skin appearance in the UVA and NIR bands (h, i);

FIG. 7 are reconstructions of a skin patch using the naive LUT search method, using white, synthetic blue and synthetic green (a), photograph of the same area (b), and reconstruction using the three-stage matching method (c);

FIG. 8 are comparisons of a facial photograph captured by Light Stage under white illumination with (b), reconstruction using 4D model of Gitlina et al. (a), and reconstruction using our 5D model (c), as well as the absolute error maps;

FIG. 9 are comparisons of UV and IR photos and outputs using three-stage LUT searching method;

FIG. 10 are the proposed neural architecture of our system consists of two networks, ChromN N and SpectraN N. The ChromN N maps multispectral albedo data (i.e. skin appearance under white, synthetic blue, and synthetic green illumination) to the five spectral model parameters, including Cₘ, βₘ, C_{hd}, Cₕₑ, and C_{bc}. The model parameters are then fed to the SpectraN N to predict a PCA-based, low-dimensional skin reflectance representation, finally reconstructed using the standard PCA reconstruction technique to obtain the full spectral reflectance in the UVA+VIS+NIR range (300 nm to 1000 nm);

FIG. 11 is a PCA reconstruction of spectral skin reflectance. The red and blue lines represent the reference reflectance and reconstruction, respectively;

FIG. 12 are comparisons of the outputs of ChromN N and corresponding references (from LUT search on the same input) of two subjects with subject 1 (Mediterranean skin type) and subject 2 (Asian skin type) using LUTs searching of Cₘ (a), Bₘ (b), C_{hd} (c), Cₕₑ (d), C_{bc} (e);

FIG. 13 are comparisons of the photos and reconstructions visualized by the estimated reflectance in the visible domain with white (a), red (b), green (c), and blue (d) illuminations;

FIG. 14 are reconstructions visualized by the estimated reflectance in the UVA and NIR domain, and in the UVA (e) and NIR (f) domains. Here, the references for the visible domain are photographs under the same illuminations, while the references for the UVA and NIR domains are the reconstructions generated by the proposed three-stage LUT searching method;

FIG. 15 are comparisons of a face and a skin patch among photo (a), the reconstruction using the proposed three-stage LUT searching method with white, synthetic green, and synthetic blue images as input (b), the reconstruction using the proposed two-stage LUT searching method with a single white image as input (c);

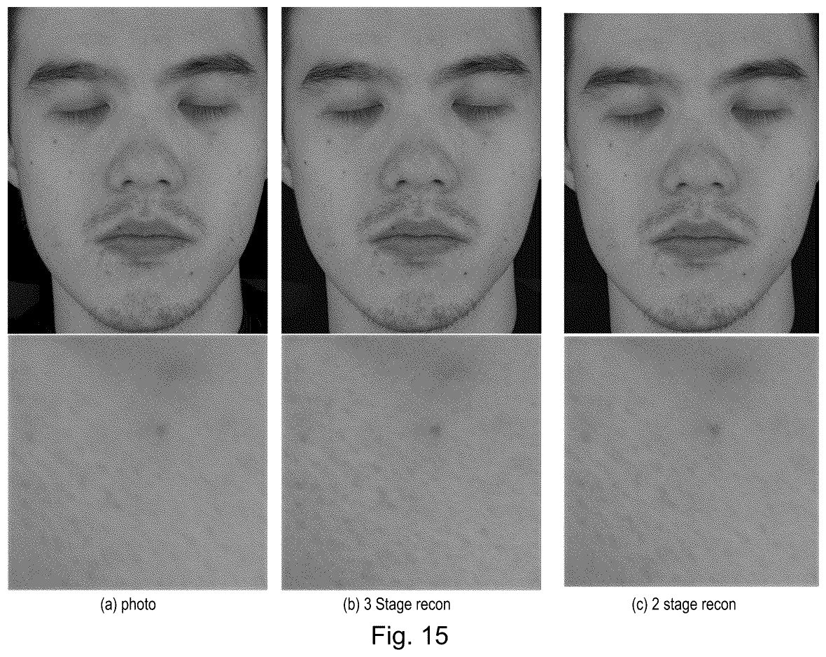

FIG. 16 are the proposed network structure with a single white LUT or image as input. The ChromN N maps white albedo data to the five spectral model parameters (Cₘ, βₘ, C_{hd}, Cₕₑ, and C_{bc}), then fed to the SpectraN N to predict a PCA-based, low-dimensional skin reflectance representation, finally reconstructed to obtain the full spectral reflectance in the UVA+VIS+NIR range (300 nm to 1000 nm);

FIG. 17 are the ten PCA components applied on the full skin reflectance; and

FIG. 18 are hydration estimation results in epidermis and dermis.

### DETAILED DESCRIPTION OF CERTAIN EMBODIMENTS

We propose a practical method to measure spectral skin reflectance as well as a spectral BSSRDF model spanning a wide spectral range from 300 nm to 1000 nm. We employ a practical capture setup consisting of desktop monitors to illuminate human faces in the visible domain to estimate five parameters of spectral chromophore concentrations including melanin, haemoglobin, and β carotene concentration, melanin blend-type fraction, and epidermal haemoglobin fraction. The estimated parameters make use of a novel three-stage lookup table search for faster parameter fitting, and drive our skin model for accurate reconstruction of facial skin reflectance response in both the visible domain as well as in the UVA and near-infrared range. Additionally, we propose a novel neural network architecture that given our measurements, predicts the five chromophore parameters of our model at the encoder stage and full hyperspectral reflectance response as output of the decoder stage.

### Introduction

Accurate facial appearance modelling has been a topic of extensive research in computer graphics and vision. Several biophysically-based spectral skin reflectance models have been proposed in recent years [2, 7, 10-12, 17, 18]. Previous works have either proposed complex biophysical models with a large number of parameters to represent various chromophores in the human skin [7, 11, 18], or employed simpler models with fewer parameters that can be practically measured [12, 17], albeit with reduced model accuracy. Most of these works have mainly focused on the visible domain, in which some facial features that are crucial for skin appearance and protection might be concealed [7].

We employ a hyperspectral BSSRDF skin appearance model spanning a wide spectral range from 300 nm to 1000 nm, thus encompassing Ultra Violet (UV), Visible (Vis) and Near InfraRed (NIR). While the employed model makes use of the spectral chromophore parameters proposed in [11], we propose a novel extension of their model to predict skin reflectance response in the UVA and NIR domain (Section 3). Therefore, the employed parameters are melanin concentration Cₘ, dermal haemoglobin concentration C_{hd}, melanin blend-type fraction βₘ, epidermal haemoglobin fraction Cₕₑ, and β carotene C_{bc} concentration. The skin model additionally includes two fixed parameters: dermal water fraction Cwd and epi-dermal water fraction C_{we}. The inclusion of β carotene in the model enables more accurate skin appearance simulation, particularly for yellowish and olive skin types. Further, we present a practical measurement approach for acquiring spectral skin reflectance based on our model. Our capture setup consists of a set of desktop LCD monitors for illuminating a face with standard visible spectrum RGB illumination in order to acquire high-quality spectral skin chromophore maps.

Previous works estimate spectral skin parameters to achieve high-quality appearance reconstructions by searching in a LookUp Table (LUT) of pre-computed skin tones the closest RGB values of facial albedo images, on a pixel by pixel basis [12, 17]. Such approach is a computationally expensive, particularly for models with higher complexity. To address this issue, we propose a novel three-stage LUT search to efficiently estimate the parameters of our model (see Section 4).

An additional issue of the LUT search approach is related to the quantization of the results it produces, due to the sampling resolutions of parameters used to generate the LUT. To overcome this limitation, we design encoder neural network (ChromN N) to estimate the five spectral parameters at the encoder stage, and a decoder neural network (SpectraN N) for reconstructing the full hyper-spectral skin reflectance. Here, hyperspectral reflectance of skin is first compressed using Principal component analysis (PCA) [14], which allows to reduce the size of the SpectraN N network, thus speeding up training and testing (Section 6). Our neural network design is a significant improvement over previous works that can only reconstruct RGB skin reflectance response under a specific target illumination spectrum [2, 12].

In summary, our major contributions are threefold:
We propose a hyperspectral skin reflectance model driven by five chromophore parameters spanning a wide spectral range from 300 to 1000 nm, and a practical measurement approach for estimating model parameters employing RGB illumination emitted by desktop LCD monitors.
We introduce a novel three-stage lookup table search for speeding up conventional LUT-based parameter fitting.
We design a novel neural network architecture to estimate the five chromophore parameters of our skin model and reconstruct full hyperspectral reflectance from the input RGB measurements.

### 2 RELATED WORK

Here, we give a brief overview of bio-physical skin appearance modelling, spectral skin appearance measurement, and hyperspectral appearance modelling (including UV and IR) in the computer graphics field.

Bio-physical Skin Appearance Modelling: Jensen et al. proposed a practical BSSRDF model to approximate the subsurface scattering for translucent materials with dipole diffusion theory. This work was extended to multipole diffusion theory to account for multi-layered translucent materials, such as human skin by Donner & Jensen [9]. Building on these, they introduced a two-layer bio-physical skin model with three chromophore parameters to simulate realistic skin appearance [10]. This model was subsequently extended and simplified by Jimenez et al. to make it suitable for practical measurement and prediction of skin color change during facial animation using a four parameter model with only two free parameters used for fitting using a lookup-table (LUT) search. Recently, Gitlina et al. employed the more complete spectral model of [17], with four free parameters to more accurately reconstruct skin appearance using measurements in a multispectral LED sphere. Besides employing LUT searching, they also proposed a cascaded neural network architecture for model fitting and RGB albedo reconstruction.

The spectral skin chromophores modelled in these works are mainly related to melanin and haemoglobin concentrations. However, there are some other blood-borne pigments, such as beta-carotene and bilirubin, which also play important roles in skin colour [7, 11, 18]. Krishnaswamy et al. introduced a parametric five-layer skin model called BioSpec to approximate the light interaction within hu-man skin. Donner et al. later proposed a layered heterogeneous reflectance model with lateral inter-scattering of light between skin layers using six parameters and an additional inter-layer absorption to model veins and tattoos in skin [11]. Although these models can simulate very realistic skin appearance, high model complexity makes measurements less practical.

Our work follows the line of previous diffusion-based bio-physical skin appearance models. We employ a practical hyperspectral skin model with five free parameters to balance model sophistication and complexity for measurements. We also propose a novel Encoder-Decoder neural network architecture to predict chromophore maps and reconstruct full spectral skin reflectance given practical RGB measurements. Similar to our work, there are some recent works that have also applied neural networks to predict chromophores [2, 12]. However, the network architectures in these works focus on reconstructing RGB facial appearance from the estimated chromophores under a specific illumination spectrum (e.g., D65). In comparison, our pro-posed network architecture achieves full spectral reconstruction of skin appearance making it suitable for visualising facial appearance under any desired illumination spectrum, spanning a wide range from UVA to Vis to NIR.

Spectral Skin Appearance Measurement: Jensen et al. proposed a simple technique for measuring RGB optical parameters of materials, including two skin samples, by illuminating the surface of a sample with a tightly focused beam of white light and acquiring a photograph with a colour camera to observe the radiant exitance across the entire surface. Donner et al. employed multispectral images of skin patches illuminated by a broadband flash and nine different chosen narrow spectral bands to measure spectral skin reflectance and drive parameter estimation for their model. Jimenez et al. used a non-contact SIAscope™ system [8] with cross-polarized flashes to measure the haemoglobin and melanin concentrations of facial skin. Close to our approach, Gitlina et al. designed a measurement approach using two complementary broad and narrow-band spectral illumination conditions using a multispectral LED sphere. They also proposed a practical skin patch measurement approach using an off-the-shelf dermatological imaging device (Miravex Antera 3D camera). Recently, Aliaga et al. [2] employed RGB albedo measurements of facial skin to estimate chromophore parameters for their full Monte Carlo simulation based skin model.

Ultraviolet (UV) and Infrared (IR) Modelling: Some deep skin dam-age gradually changes facial appearance and skin health due to UV light exposure. The prediction of the pigmentation irregularities, such as freckles and moles, is beneficial to help people slow down aging [5, 15] and protect their skin from photodamage effects and skin cancer risk [1]. In addition to pigmentation, skin hydration is another significant factor to describe skin status [7]. Water displays strong absorption in the IR domain, thus IR photographs can provide information about skin hydration [4].

Existing research related to light and skin interactions in the computer graphics field mainly focuses on skin imaging in the visible domain. A notable exception is the work of Chen et al. [7] who first introduced a hyperspectral skin appearance model to comprehensively forward simulate spectral and spatial distributions of light interacting with human skin from the UV to IR domain involving a large set of skin chromophores. While we borrow from this work, we present a more practical model with fewer parameters to model skin reflectance over a wide spectral range spanning UVA-Vis-NIR domains.

### 3 SPECTRAL BIO-PHYSICAL SKIN MODEL

We introduce our diffusion-based bio-physical skin appearance model and data acquisition in Section 3.1 and Section 3.2, respectively. Similarly to previous work [10, 12], we model skin as a two-layer translucent material.

### 3.1 Overview

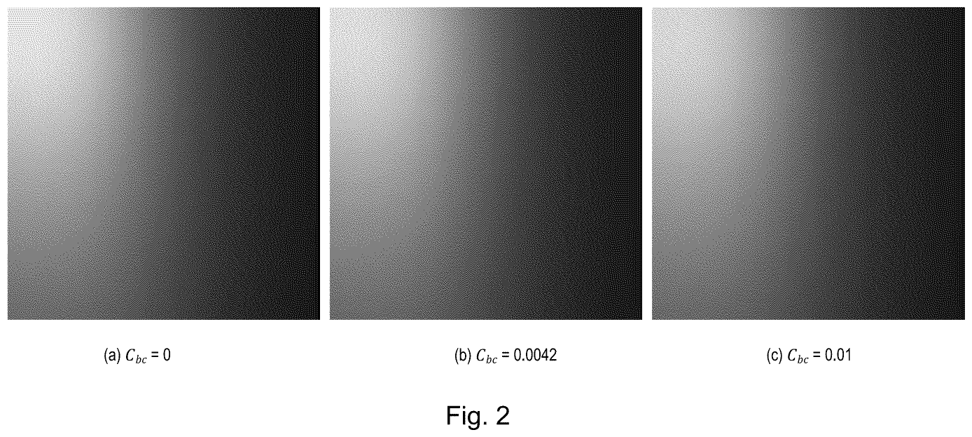

We propose a novel spectral skin appearance model driven by five biophysical parameters, namely melanin concentration Cₘ, melanin type blend βₘ (blend between eumelanin and pheomelanin), dermal haemoglobin concentration C_{hd}, epidermal haemoglobin concentration Cₕₑ, and β carotene fraction C_{bc}. Additionally, we fix the values of the two parameters C_{wd} and C_{w}, respectively representing water in the epidermis and dermis. The inclusion of β carotene, an important skin chromophore, has the advantage of extending the skin model colour gamut and improving the simulation of yellowish and olive human skin tones [3, 11]. As shown in FIG. 2, the lookup table becomes more yellow as the β carotene fraction increases. Even a small change of β carotene can make a great contribution to skin colour.

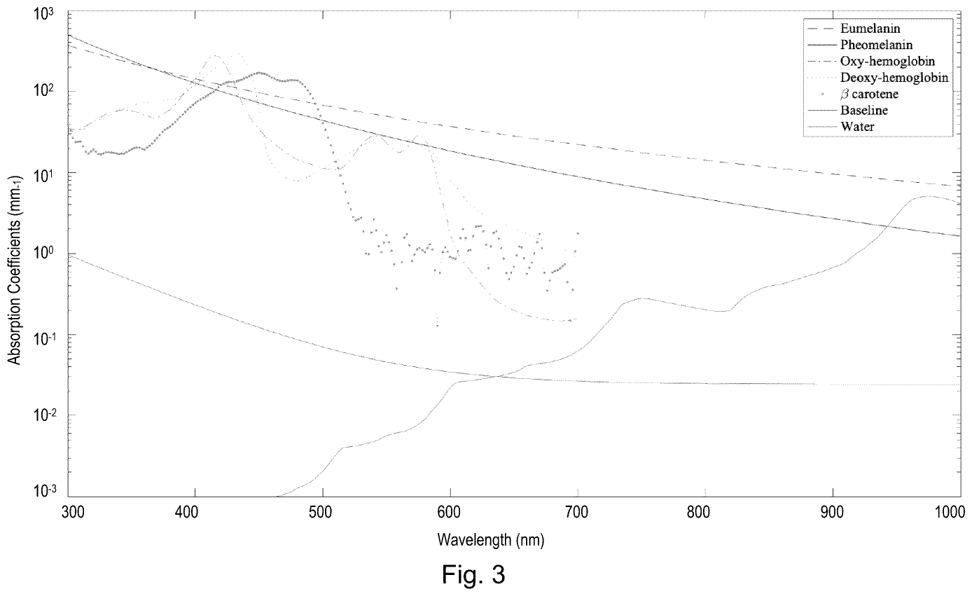

The model parameters not only control skin colour in the visible domain, but they are also significant absorbers in the UVA and near-infrared domain. FIG. 3 shows the spectral absorption coefficients of the parameters in our model, spanning from 300 nm to 1000 nm. Five free parameters can be used to effectively simulate skin appearance in the UVA and Visible domain while two fixed water parameters can be applied to simulate the appearance in the Visible and NIR domain, thus enabling our model to cover the 300 nm to 1000 nm range. The proposed novel equations of absorption of the epidermis and dermis are as follows:

$${σ}_{a}^{epi} ( λ ) = ( 1 - {C}_{we} ) ( {C}_{m} ( {β}_{m} {σ}_{a}^{em} ( λ ) + ( 1 - {β}_{m} ) {σ}_{a}^{pm} ( λ ) ) + {C}_{he} ( {γσ}_{a}^{oxy} ( λ ) + ( 1 - γ ) {σ}_{a}^{deoxy} ( λ ) ) ) + {C}_{bc} {σ}_{a}^{bc} ( λ ) + ( 1 - {C}_{m} - {C}_{he} - {C}_{bc} ) {σ}_{a}^{base} ) + {C}_{we} {σ}_{a}^{w} ( λ ) \qquad ( 1 )$$

$${σ}_{a}^{derm} ( λ ) = ( 1 - {C}_{wd} ) ( {C}_{hd} ( {γσ}_{a}^{oxy} ( λ ) + ( 1 - γ ) {σ}_{a}^{deoxy} ( λ ) ) ) + ( 1 - {C}_{hd} ) {σ}_{a}^{base} ) + {C}_{wd} {σ}_{a}^{w} ( λ ) \qquad ( 2 )$$

Here, λ is the wavelength of light in nanometres, Cₘ represents melanin fraction, βₘ represents melanin type blend between eumelanin and pheomelanin, with

$${σ}_{a}^{em} and {σ}_{a}^{pm}$$

respectively being their absorption coefficients. C_{hd} and Cₕₑ refer to haemoglobin fraction in dermis and epidermis while y is the blood oxygenation ratio between deoxy- and oxy-haemoglobin (fixed as 0.75), with

$${σ}_{a}^{oxy} and {σ}_{a}^{deoxy}$$

respectively being their absorption coefficients. C_{bc} and

$${σ}_{a}^{bc}$$

represent the volume fraction and absorption coefficient of β carotene. C_{we} and C_{wd} represent water fractions in the epidermis and dermis, fixed as 0.2 and 0.6, respectively. The absorption coefficient of water is

$${σ}_{a}^{w} \cdot {σ}_{a}^{bc}$$

is the baseline absorption of skin tissues. Therefore, Cₘ, βₘ, Cₕ, Cₕₑ and C_{bc} compose to the 5D parameter space of this model, as shown in Table 1.

TABLE 1
Physiological parameters describing skin spectral absorption and scattering.

| Parameters | Sampling | Spectral Range |
|---|---|---|
| Cₘ | 0-0.5 | UV-Vis-IR |
| βₘ | 0-1 | UV-Vis-IR |
| Cₕ | 0-0.5 | UV-Vis |
| Cₕₑ | 0-0.3 | UV-Vis |
| C_{bc} | 0-0.01 | UV-Vis |
| C_{we} | 0.2 | Vis-IR |
| C_{wd} | 0.6 | Vis-IR |

### 3.2 Acquisition

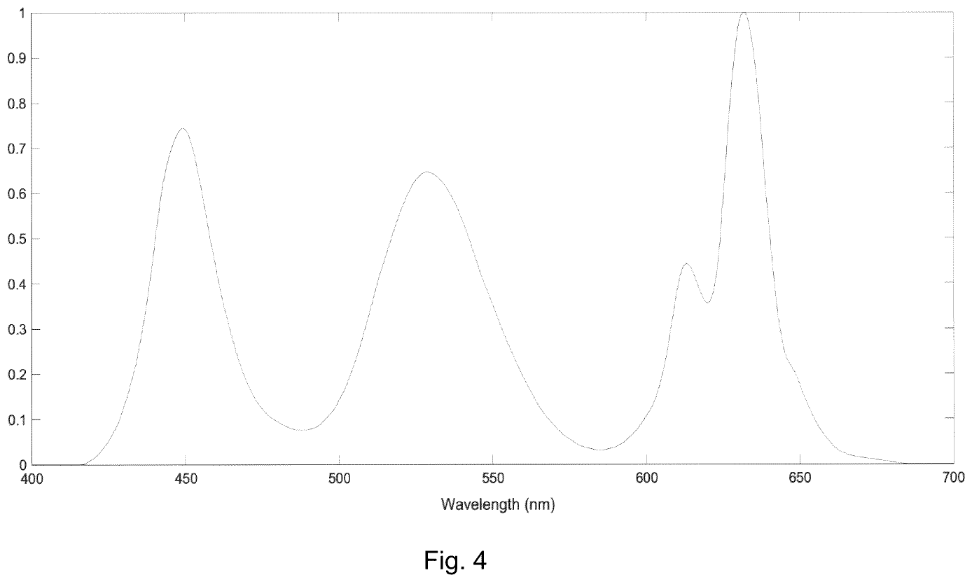

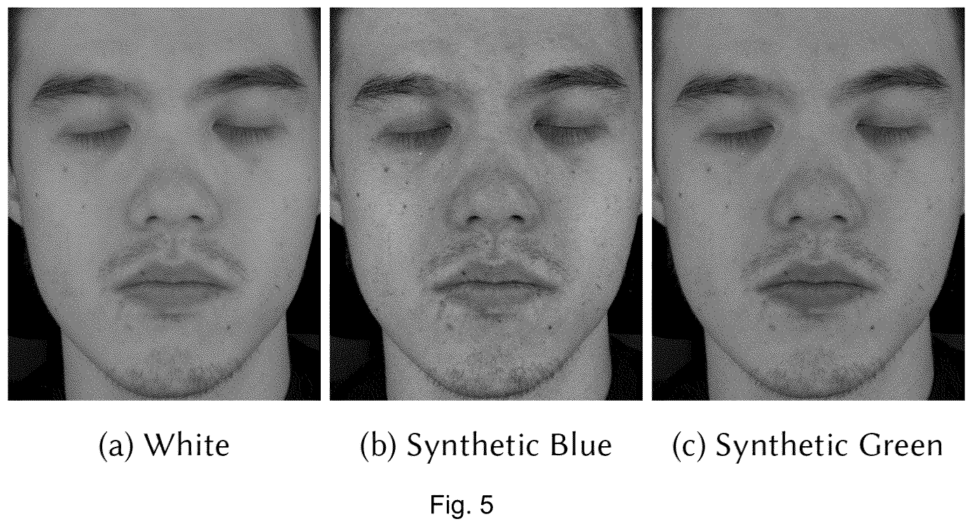

We employ a practical monitor-based setup for high-quality facial capture, equipped with four 4K desktop LCD monitors and a set of cameras (Canon EOS M6 Mark II) placed in between the monitors, to obtain multi-view acquisitions of the subjects. FIG. 4 shows the Spectral Power Distribution (SPD) of the screens white illumination (6500K CCT), as measured by a Sekonic SpectroMaster C700 spectrometer. As visible in the plot, the peak of blue illumination is at around 450 nm. However, according to Preece and Claridge [19], the optimal illumination to measure melanin is narrowband blue with a peak of around 485 nm. Therefore, while directly using the narrow band blue illumination in our setup might not be optimal for melanin measurement, it provides cues to estimate β carotene, as the maximal absorption of the latter is closely aligned to the peak of blue illumination. In addition, narrowband green illumination is also useful to measure haemoglobin [19]. As observed in Gitlina et al. [12], directly observing skin response under narrowband illumination can lead to sub-optimal measurements, due to colours outside the gamut of typical off-the shelf RGB cameras. Hence, we make use of multiple illuminations such as white illumination, a mix of white and blue illumination, and a mix of white and green, and employ a computational scheme similar to the one by Gitlina et al. to synthesize sharper blue and green narrowband responses from the mixtures (FIG. 5). Acquisition could alternatively be done using a set of visible spectrum LED light-sources or LED panels for illuminating a subject, or in combination with one or more displays for the illumination.

### 4 PARAMETER ESTIMATION

The most straightforward approach to parameter estimation is to use pre-computed 5D LookUp Tables (LUTs) of skin colours, one for each of the 3 lighting spectra described in Sec 3.2. For each pixel in the RGB photograph acquired under broadband white light, and in the grayscale synthesized blue and green images, we search the corresponding LUTs, finding the set of skin parameters that minimizes the L2 distance in CIELAB colour space (i.e. ΔE₇₆ colour difference), thus obtaining the estimated skin parameter maps. Radiometric calibration is achieved by scaling the LUTs intensities by constant scalars. Such scalars are derived by taking photographs of the X-Rite colour chart under the illumination conditions used in this work. For each lighting condition, the observed RGB intensity I_{CC}_{ₗₛ} of the colour patch representing light skin, with known spectral reflectance, is used as a reference; the entire LUT is then scaled by the factor

$$\frac{{I}_{{CC}_{ls}}}{{I}_{{CC}_{cm}}} ,$$

where I_{CC}_{_{cm}} is the RGB intensity of the closest skin reflectance spectrum in our model to the one of the light skin colour patch.

Additionally, we can use an optical flow algorithm on the input images to reduce the impact of subjects' movement during the acquisitions.

### 4.1 Novel Three-Stage LUT Searching Method

As shown in previous work, the naive LUT search can produce high-quality results, which we show can be further improved for yellowish and olive skin tones by including β carotene in the model. However, the increased model complexity leads to larger LUTs and longer matching time. In order to address this issue, we propose a three-stage matching method to take advantage of the larger parameter space, while reducing the computational cost without affecting the quality of the estimated parameter maps. In the following, we provide an overview of the proposed search strategy.
Stage 1: we keep the β-carotene value fixed, thus focusing on 4D slices of the LUTs. We then query the broadband white and synthetic blue LUTs to estimate the melanin-related parameters Cₘ and βₘ;
Stage 2: The estimated Cₘ and βₘ in stage 1 are kept constant, while using broadband white and synthetic blue LUTs to search the resulting 3D slices for the optimal C_{bc}. While this search also provides estimates for the haemoglobin-related parameters, these are discarded;
Stage 3: the values of Cₘ, βₘ and C_{bc} estimated in the previous stages are kept fixed, thus leading to a 2D search space. We then use white and synthetic green to search for the two optimal haemoglobin parameters C_{hd} and Cₕₑ.

The β-carotene value used in the first stage has been derived as the mode of the distribution of the estimated β-carotene values on a training dataset containing photographs of subject with different skin types. The estimated values are obtained using the naive, full search strategy.

Compared to the full search, the above strategy allows a significant speed up of the maps estimation, and allows incorporating knowledge of the most suitable lighting condition to estimate a given skin parameter (see Sec. 3.2). In fact, while blue illumination excite melanin and β carotene (stages 1 and 2), green illumination provides useful information about haemoglobin (stage 3).

### 4.2 Estimation Results

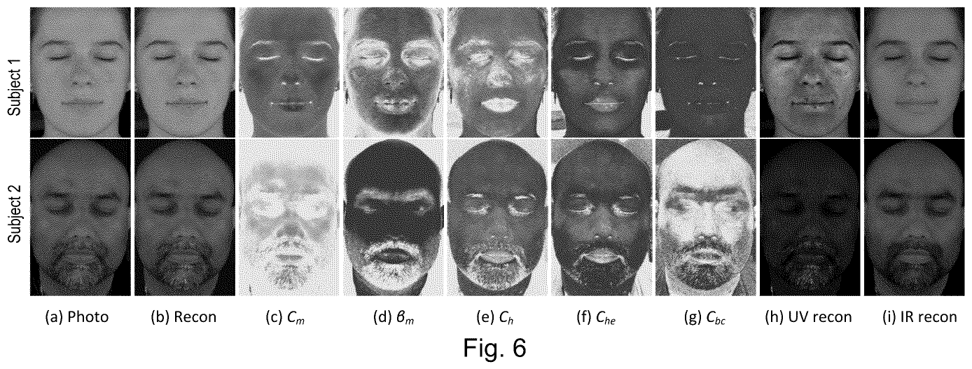

FIG. 6 (a, b) compares the albedo reconstruction using the three stage matching method with the ground truth photograph, for a subject with Caucasian skin type (top row) and a South Asia skin type (bottom row); in (c-g) we report the corresponding estimated chromophore maps while in (h, i) we displays the UVA and NIR reconstructions. As it can be seen, for both skin types the reconstructions closely match the photographs. It can also be noted that β carotene maps show significant differences between the two skin types (see FIG. 6 (g)), with the darker skin containing a larger amount of β carotene.

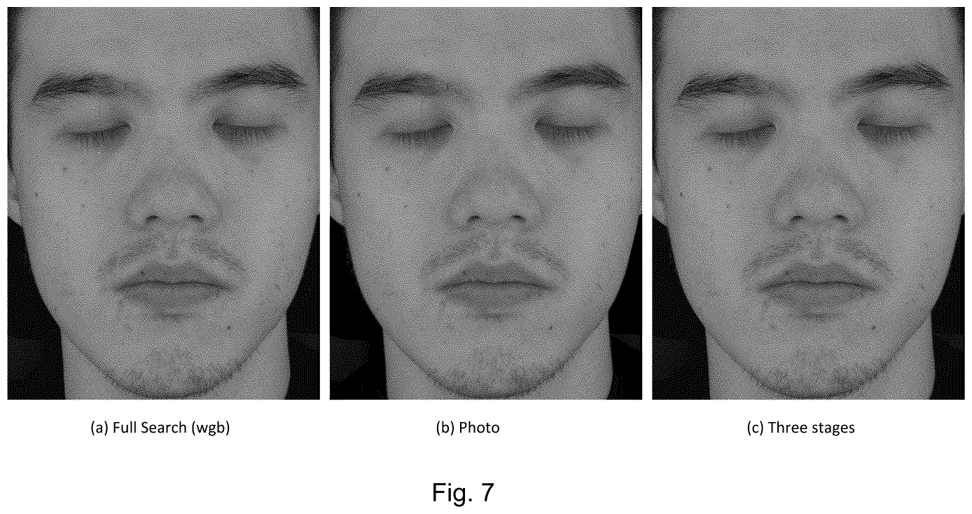

In FIG. 7 we compare the reconstruction with Asia skin type using the naive full search matching method (a), which takes in input the broadband white along with synthetic blue and synthetic green images, with the reconstruction given by the three-stage matching method (c). As shown in the figure, the results of the two methods are qualitatively similar to the ground truth photograph.

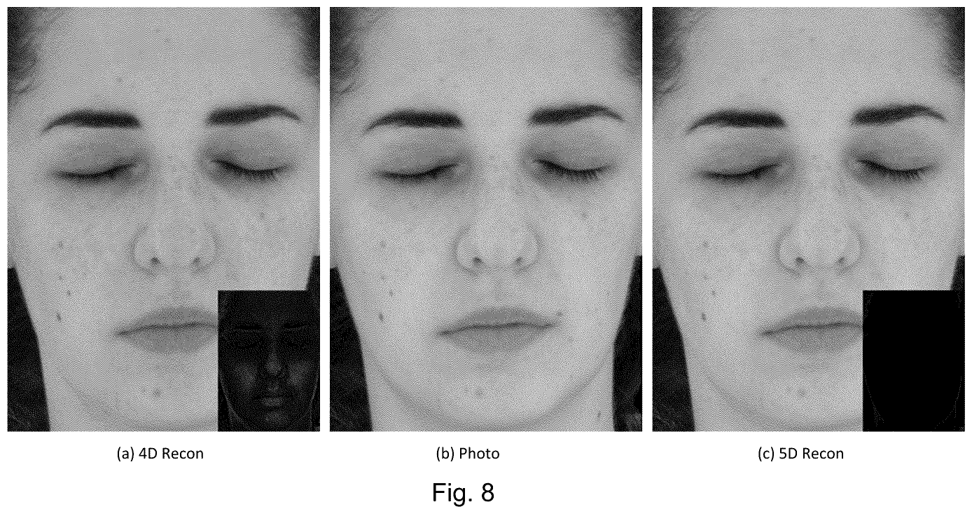

We also compare with Gitlina et al. using their data, acquired using their Light Stage. In FIG. 8 we report a photograph of the subject under white illumination (b), its reconstruction using 4D model employed by Gitlina et al. [12], which does not include β-carotene and water (a), and the reconstruction using our 5D model, which includes the parameter Cbc (c). The comparison of the absolute error maps in the right corner of reconstructions displays that our model produces a closer reconstruction of the photograph, and it is not limited to data acquired with our device.

### 5 ULTRAVIOLET (UV) AND NEAR-INFRARED (NIR) VALIDATION

As previously note, the chromophores-related parameters used in our model absorb light significantly both in the visible and invisible range. Therefore, once the five chromophore maps have been estimated using visible light, we can infer skin appearance in the UV and IR domain by plugging in our forward model the corresponding absorption coefficients.

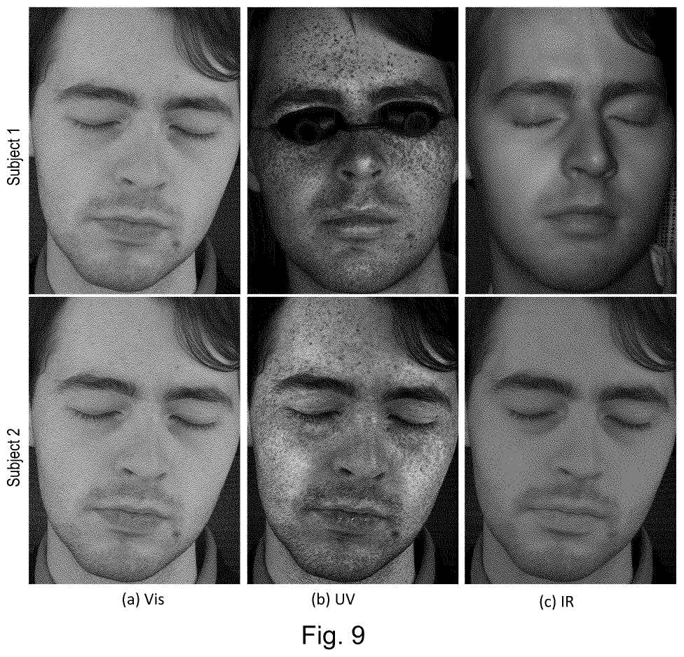

To validate the predicted UVA and NIR appearance, we employ a UV camera (fx0487MXGE) without an IR-cut filter to acquire facial images. Subjects are illuminated by a UV LED tube in the 300-400 nm, and by IR LED panel in the 700-1000 nm range. FIG. 9 compares the photos and reconstructions of the same subject in the UVA, visible and NIR domains. As FIG. 9 (b,e) show, in UVA domain some inconspicuous spots around the cheek and forehead are much more evident than in the visible domain, which is consistent with the conclusion that UV photos can display more facial details, and it is helpful to remind people to protect their skin or find potential skin diseases. On the other hand, FIG. 9 (c,f) displays the photo and reconstruction in the NIR domain, where the faces look softer and less influenced by pigmentations.

### 6 NEURAL NETWORK

As shown in the previous Section, the use LUTs to infer model parameters by searching for the closest match to the colour of acquired human skin can lead to good results. However, even by using the 3-stage approach, parameter estimation is still relatively slow. More important, the values contained in the maps are quantized due the discretization of the LUTs. In order to address these issues, we propose the use of an Encoder-Decoder Neural Network for estimating model parameters and skin reflectance from 300 nm to 1000 nm, thus including both UVA, visible and near-infrared range.

### 6.1 Network Architecture

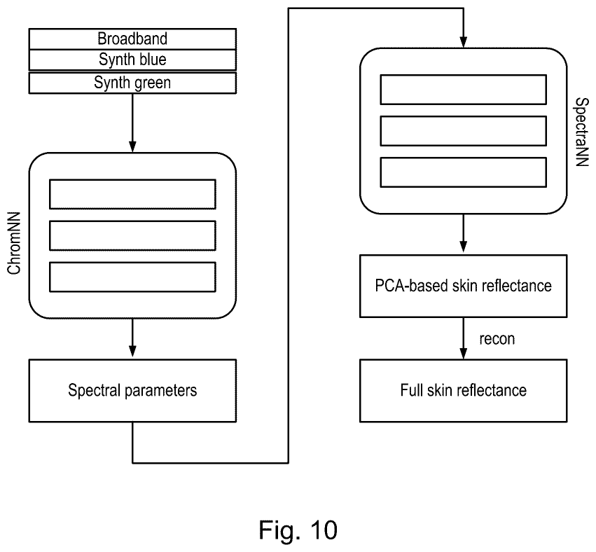

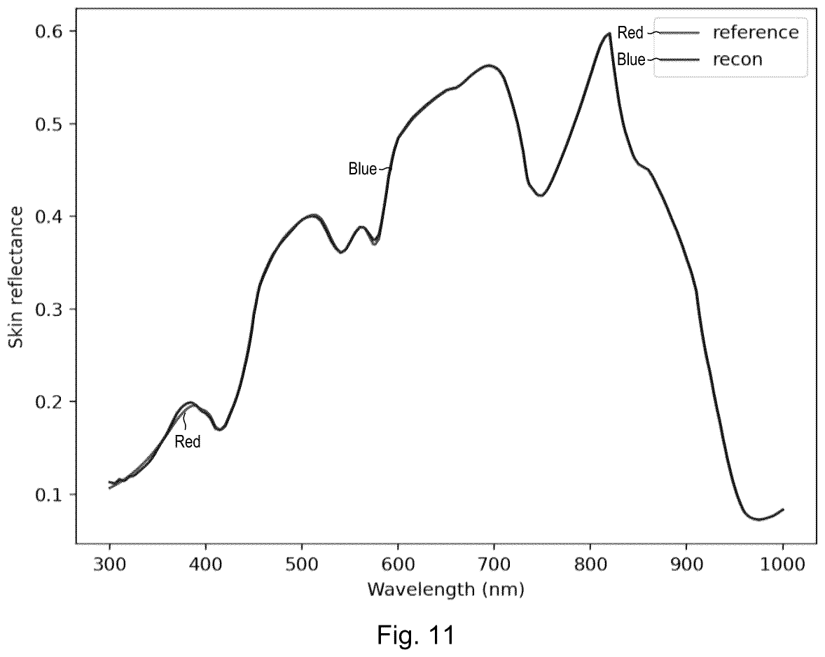

Our network architecture consists of two networks, as shown in FIG. 10. The ChromN N network predicts the 5 model parameters from the 5D multispectral skin albedo (RGB from acquired photograph under white light, plus blue and green grayscale data). The estimated parameters are fed into the SpectraN N network, that approximate the equations in our model to output spectral skin reflectance. However, directly producing in output densely sampled spectral data (e.g. 300 nm-1000 nm in 2 nm steps 2 nm), poses issues due to a large number of required output neurons, resulting in larger network size and noisy estimates. Therefore, we apply Principal Component Analysis (PCA) to the spectral skin reflectance data in the training set (572,220 spectra), retaining the first 10 principal components, which explain ~100% of the total variance and using the network to map from the multispectral skin albedo to the eigenvalues obtained with PCA. Both networks are implemented as Multi-layer Perceptrons (MLPs), with three and four hidden layers, respectively. FIG. 11 shows the comparison between skin reflectance and PCA reconstruction which is achievable from the first 10 PCA com-ponents of skin reflectance closely matches the spectral reflectance sampled at 2 nm resolution.

Datasets: The training set of this network is the augmented LUTs of the proposed 5D spectral skin reflectance model visualized by white, blue, and green illuminations. Each RGB value in the LUT corresponds to five spectral parameters, 201-value skin reflectance and 10-value PCA-based reflectance. In detail, the training input of the ChromN N are the RGB values in the LUTs and the ground truth are the five chromophores, which are also the training input of the SpectraN N. The ground truth of the SpectraN N is the 10-value PCA-based reflectance. The testing dataset of these networks is the facial images under the same illumination (white, blue and green), and the references are the LUT searching results. The chromophores references cannot be regarded as the ground truth, however, the photographs under different illuminations can be the ground truth of the visualization of the predicted skin reflectance. Implemental details: The ChromN N and SpectraN N are separately optimized with learning rates 3e-4. Adam solver with weight decay=1e-6 is adopted for the optimization. The ChromN N applies Sigmoid activation function while the SpectraN N applies Relu activation function. All experiments were conducted on Titan X GPUs. The loss function for both networks is Mean Squared Error (MSE) loss function.

### 6.2 Network Results

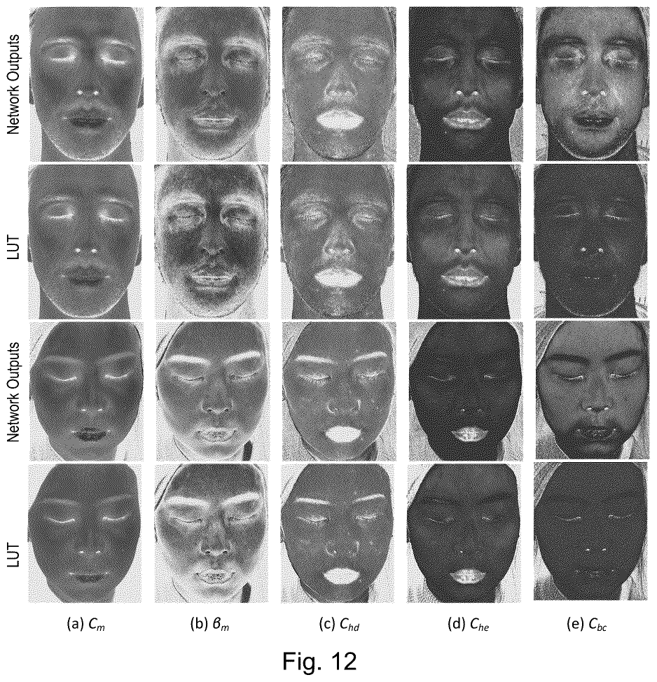

FIG. 12 compares the outputs of the ChromN N network and the reference maps generated by the proposed three-stage LUT searching method. As can be seen, the network results have similar quality to the reference maps from LUT search. In general, chromophore maps from the neural architecture show less noise and less quantization as the ones from LUT search, particularly noticeable in the βₘ maps.

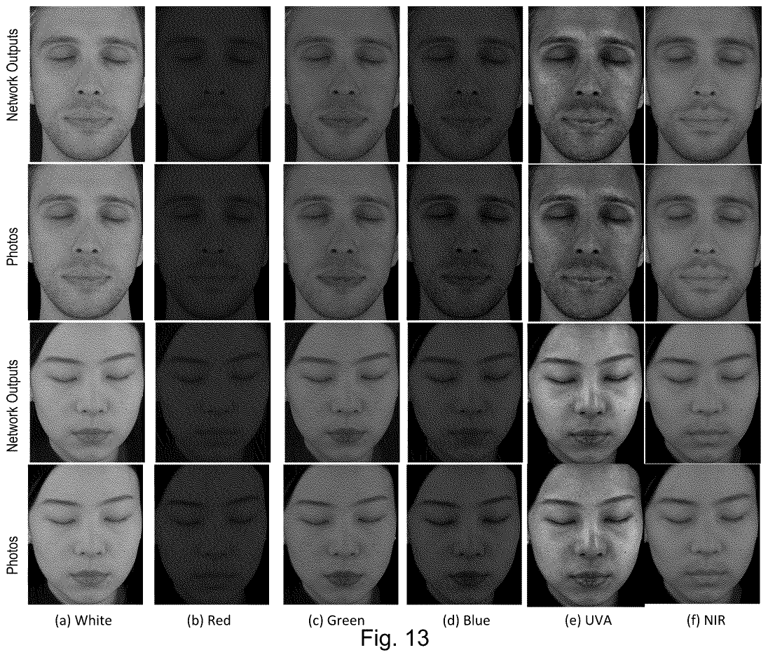

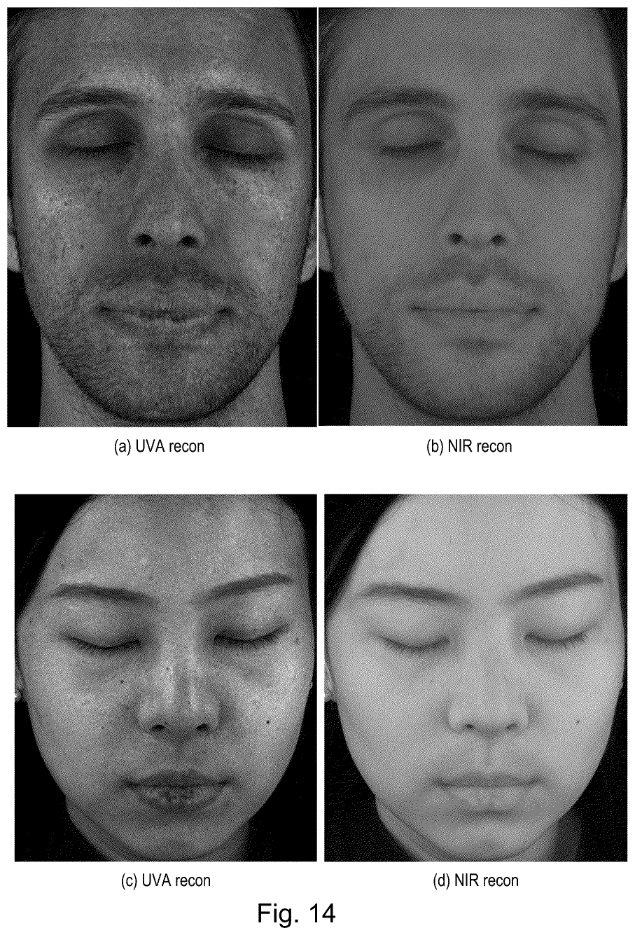

After feeding the outputs of ChromN N into the SpectraN N, we can obtain the estimated 10-value PCA-based skin reflectance which needs to be reconstructed into full reflectance. FIG. 13 compares the photos and reconstructions visualized by the estimated reflectance in the visible domain with white (a), red (b), green (c), and blue (d) illuminations. Additionally, we also reconstruct facial appearance in the UVA and NIR domains, as shown in FIG. 14.

### 7 CONCLUSION

A novel spectral skin reflectance model with five chromophore-related parameters, able to faithfully represent spectral reflectance of human skin in the 300 nm to 700 nm range is described. To estimate such parameters, we present a practical measurement method, which makes use of a monitor-based facial capture system. For parameter estimation, we introduce a new three-stage method to speed up conventional lookup table search. While parameters are estimated parameters in the visible range, we leverage our spectral model to estimate skin appearance also in the UV domain. Moreover, we propose a novel network architecture to estimate the model parameters and reconstruct full spectral reflectance from the input measurements. The knowledge of spectral reflectance enables us with the capability to reconstruct skin appearance under different uniform illumination conditions with respect to the ones used to acquire input data.

### APPENDIX A: PARAMETER ESTIMATION USING ARBITRARY BROADBAND-ONLY INPUT

Our method can work with a single photograph in input, taken under broadband illumination. The spectrum of the broadband illumination can be measured with a spectrometer such as the Sekonic SpectroMaster C700. Otherwise, the illumination spectrum can be estimated in any arbitrary environment and under any incident illumination (e.g. sunlight, LED, sodium-vapor lamps, etc.) by using the spectral upsampling approach by Guarnera et al. [13], thus recording the incident illumination at the desired location by means of a RGB light probe (e.g. a HDR sequence of a mirrored sphere) and upsampling the averaged RGB values corresponding to the incident illumination over the subject's face.

To estimate model parameters, we apply a two-stage search strategy to speed up the naive full search, as described in the following:
Stage 1: similarly to the three-stage search, we keep the β-carotene volume fraction (C_{bc}) fixed, then search the resulting 4D slice of the broadband LUT for the optimal parameters Cₘ and βₘ;
Stage 2: The estimated Cₘ and βₘ derived in stage 1 are kept constant while searching the resulting 3D slices for other three parameters C_{h, he} and C_{bc}.

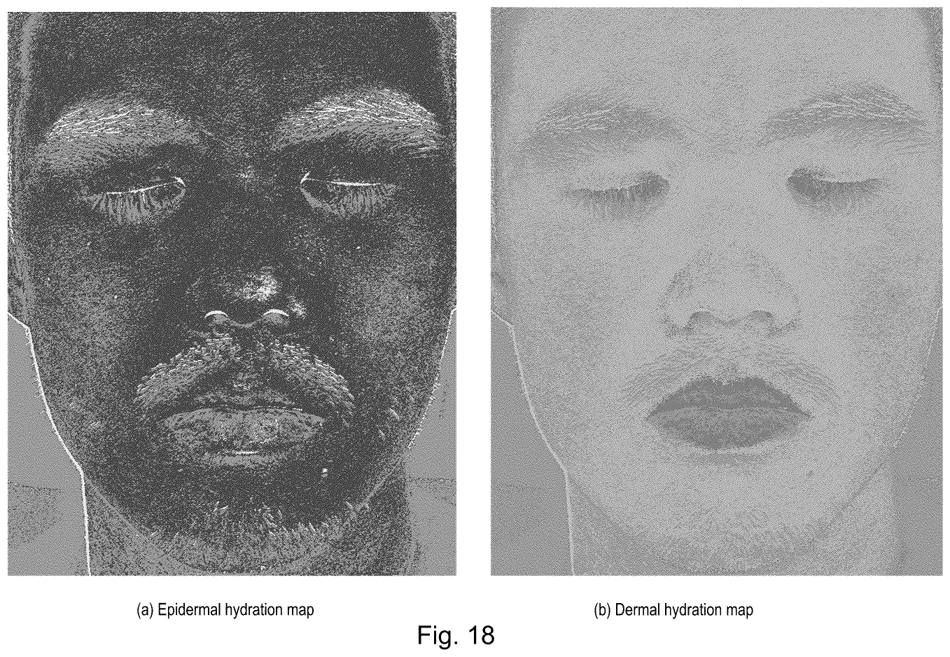

The fixed C_{bc} value used in the first stage is the same as the one in Section 4. FIG. 18 compares the ground truth photographs of a face (top row) and of a skin patch (bottom row) with the reconstructed albedo using only a single broadband white image in input (third column) and using multispectral acquisitions (broadband white along with synthetic blue and synthetic green, middle column). As it can be seen, the reconstruction (FIG. 18 (c)) using the two-stage LUT searching method is close to the ground truth photograph (FIG. 18 (a)). However, the reconstruction using the proposed three-stage LUT searching method (FIG. 18 (b)) is sharper than that using the two-stage method, as noticeable in the skin patch images.

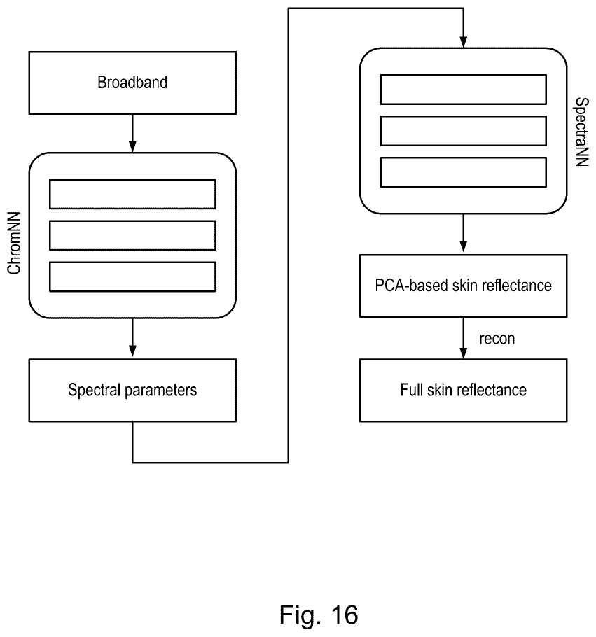

Our neural architecture can also be adapted to work with a single broadband white image in input, predicting the five spectral parameter maps and PCA-based skin reflectance, which are further transformed to the full skin reflectances shown in FIG. 16. Other details of training and testing datasets and implementation can be seen in Section 6.

### APPENDIX B: PRINCIPAL COMPONENT ANALYSIS (PCA)

In our model, the full skin reflectance is sampled densely from 300 nm to 1000 nm in 2 nm. Directly using the full reflectance as out-puts of our proposed network results in a large network structure and a long training and testing time. Therefore, we apply Principal component analysis (PCA), one of the most popular approaches for dimensionality reduction of large datasets [14], on a dataset containing full skin reflectances and extracting the first 10 principal components, as described in Sec. 6.1. The spectral dataset used in this analysis is generated using our model, spanning the entire range of parameters reported in Table 1. In our implementation, we use the Python function sklearn.decomposition.PCA in the scikit-learn library to implement PCA analysis and reconstruction.

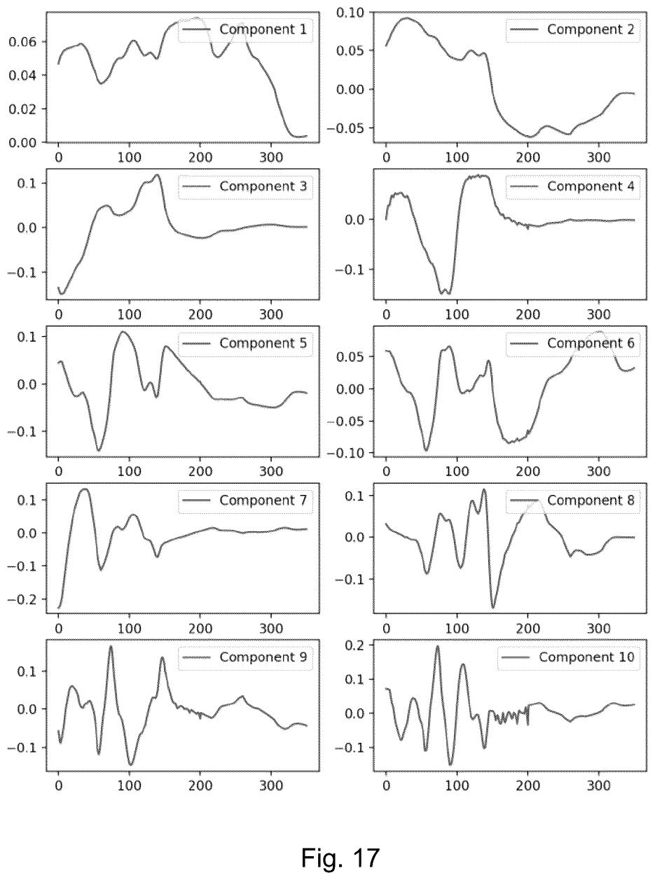

The first 10 principal components are shown in FIG. 17. Using such components, any given skin reflectance spectrum can be reconstructed using a 10d vector containing one weight for each of the 10 principal components, along with the mean spectral reflectance of the dataset. The SpectraN N network is then trained to associate input chromophore values to the PCA representation of the corresponding spectral skin reflectance; input chromophore values can be provided by the ChromNN network, or by the LUT search approaches described in this work.

Similarly, when testing the proposed networks, we first input a single white image or white and synthetic images into the ChromN N to predict the five chromophore maps, which are fed into the following network SpectraN N to obtain the PCA-based skin reflectance. With the same PCA estimator of the training dataset, we further reconstruct these low-dimensional outputs to the corresponding full reflectances over UVA, visible, and NIR domains. We can visualize the reconstructed reflectance in the visible domain with different uniform illuminations to simulate faces under different lightings (FIG. 13), and UVA and NIR maps with those in the invisible domain (FIG. 14).

### APPENDIX C: HYDRATION ESTIMATION BY INCLUDING AN ADDITIONAL NARROWBAND MEASUREMENT

Skin hydration is an important factor in reflecting skin status. Our proposed model contains two parameters C_{we} and C_{wd} to reflect the water concentrations in the epidermis and dermis, which are kept fixed when using in input just a single broadband measurement or broadband plus green and blue narrowbands. However, as reported in FIG. 3, water absorption becomes significant for wavelength longer than 600 nm. Therefore, an additional skin measurement taken under narrowband red illumination can help estimating the skin hydration map.

In order to simulate facial water distributions in the epidermis and dermis, we generate an additional LUT under narrowband red illumination, by varying also the value of the parameters C_{we} and C_{wd} to assume different values. In particular, C_{we} takes values in the range [0.1-0.25], while C_{wd} is defined in the range [0.5-0.75] [6]. In our implementation, the narrowband red illumination is given by the red channel of the monitor setup, with the main peak at 630 nm and a secondary peak at 615 nm, while both C_{we} and C_{wd} are sampled at regular steps (0.05) within their respective range.

Once the five model parameters Cₘ, βₘ, C_{hd}, Cₕₑ and C_{bc} have been estimated as described in previous Session, they are kept fixed in the following, thus identifying a 2D slice of the narrowband red LUT. The latter is than queried using the narrowband red photo-graph to estimate the water-related parameters. The estimation can be carried out in two different ways:
by searching for the optimal C_{we} and C_{wd} together, constraining C_{we} to be a scalar of C_{wd};
by estimating hydration maps in the different skin layers in-dependently. To estimate the epidermal hydration map (C_{we}), we keep the parameter Cwd fixed to the value at the centre of its domain of definition, searching the optimal C_{we} (FIG. 18a). Once the C_{we} map has been determined, we keep these values fixed C_{we} and search for the optimal C_{wd}, to retrieve the dermal hydration map.

### Modifications

It will be appreciated that various modifications may be made to the embodiments hereinbefore described. Such modifications may involve equivalent and other features which are already known in the methods of image processing, including processing the inputs to fit parameter maps for a hyper-spectral bidirectional scattering surface reflectance distribution function skin appearance model spanning UVA-Vis-NIR range of spectral bands thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A method of image processing, comprising:
receiving inputs comprising a first RGB image of human skin, the first image corresponding to a first, visible spectrum broadband illumination condition;
processing the inputs to fit parameter maps for a hyperspectral bidirectional scattering surface reflectance distribution function skin appearance model, the parameter maps comprising a melanin concentration, a melanin blend-type fraction, a dermal haemoglobin concentration, an epidermal haemoglobin concentration and a beta-carotene concentration, wherein at least four of the parameter maps are independent.

2. The method of claim 1, wherein the inputs further comprise a second RGB or greyscale image which has the same field of view and contents as the first image, the second image corresponding to a second visible spectrum illumination condition which comprises a first narrowband illumination condition.

3. The method of claim 1, wherein the inputs further comprise a third RGB or greyscale image which has the same field of view and contents as the first image, the third image corresponding to a third visible spectrum illumination condition which comprises a second narrowband illumination condition.

4. The method of claim 1, wherein the inputs further comprise a fourth image corresponding to a fourth visible spectrum narrowband illumination condition generated using a first colour channel of the first image.

5. The method of claim 1, wherein the inputs further comprise a fifth image corresponding to a fifth visible spectrum narrowband illumination condition generated using a second colour channel of the first image.

6. The method of claim 1 wherein processing the inputs to fit the parameter maps comprises:
receiving a first five-dimensional look up table corresponding to the first illumination condition, the first look-up table comprising RGB values as a function of the melanin concentration, the melanin blend-type fraction, the dermal haemoglobin concentration, the epidermal haemoglobin concentration and the beta-carotene concentration;
for each pixel of the first image:
determining a melanin concentration, the melanin blend-type fraction, the dermal haemoglobin concentration, the epidermal haemoglobin concentration and the beta-carotene concentration that minimise a distance metric in colour space between the corresponding look up table value and the pixel of the first image.

7. The method of claim 6 wherein determining the melanin concentration, the melanin blend-type fraction, the dermal haemoglobin concentration, the epidermal haemoglobin concentration and the beta-carotene concentration for each pixel comprises:
for a first beta-carotene concentration equal to a pre-determined value, determining a first melanin concentration and a first melanin blend-type fraction that minimise a distance metric in colour space between the corresponding look up table value and the pixel of the first image; and
for the first melanin concentration and first melanin blend-type fraction equal to the determined values, determining a first dermal haemoglobin concentration, first epidermal haemoglobin concentration, and second beta-carotene concentration that minimise a distance metric in colour space between the corresponding look up table value and the pixel of the first image.

8. The method of claim 2 wherein processing the inputs to fit the parameter maps comprises:
receiving a first five-dimensional look up table corresponding to the first visible spectrum illumination condition comprising RGB values as a function of the melanin concentration, the melanin blend-type fraction, the dermal haemoglobin concentration, the epidermal haemoglobin concentration and the beta-carotene concentration;
receiving, a second five-dimensional look up table corresponding to receiving a first five-dimensional look up tables corresponding to the first visible spectrum illumination condition comprising RGB values as a function of the melanin concentration, the melanin blend-type fraction, the dermal haemoglobin concentration, the epidermal haemoglobin concentration and the beta-carotene concentration;
for each pixel of the first image and the second or fourth image:
for a first beta-carotene concentration equal to a pre-determined value for the first and second look up tables, determining a first melanin concentration and a first melanin blend-type fraction based on respective melanin concentrations and melanin blend-type fractions that minimise a distance metric in colour space between the corresponding look up table values and the pixels of the first and second or fourth image; and
for the melanin concentration and melanin blend-type fraction equal to the first melanin concentration and first melanin blend-type fraction, determining a second beta-carotene concentration based on respective beta-carotene concentrations that minimise a distance metric in colour space between the corresponding look up table values and the pixels of the first and second or fourth image.

9. The method of claim 8, further comprising:
for each pixel of the first image and the second or fourth image:
for the second beta-carotene concentration, the first melanin concentration and first melanin blend-type fraction, determining a first dermal haemoglobin concentration, and first epidermal haemoglobin concentration based on respective dermal haemoglobin concentrations, and epidermal haemoglobin concentrations that minimise a distance metric in colour space between the corresponding look up table values and the pixels of the first and second or fourth image.

10. The method of claim 1 wherein processing the inputs to fit the parameter maps comprises:
receiving a first five-dimensional look up table corresponding to the first visible spectrum illumination condition comprising RGB values as a function of the melanin concentration, the melanin blend-type fraction, the dermal haemoglobin concentration, the epidermal haemoglobin concentration and the beta-carotene concentration;
receiving, a second five-dimensional look up table corresponding to the second or fourth visible spectrum illumination conditions, each look-up table comprising RGB values or greyscale values as a function of the melanin concentration, the melanin blend-type fraction, the dermal haemoglobin concentration, the epidermal haemoglobin concentration and the beta-carotene concentration;
receiving a third five-dimensional look up table corresponding to the third or fifth visible spectrum illumination conditions, each look-up table comprising RGB values or greyscale values as a function of the melanin concentration, the melanin blend-type fraction, the dermal haemoglobin concentration, the epidermal haemoglobin concentration and the beta-carotene concentration;
for each pixel of the first image and either second or fourth images:
for a first beta-carotene concentration equal to a pre-determined value for the first and second look up tables, determining a first melanin concentration and a first melanin blend-type fraction based on respective melanin concentrations and melanin blend-type fractions that minimise a distance metric in colour space between the corresponding look up table values and the pixels of the first and second or fourth image; and
for the melanin concentration and melanin blend-type fraction equal to the first melanin concentration and first melanin blend-type fraction, determining a second beta-carotene concentration based on respective beta-carotene concentrations that minimise a distance metric in colour space between the corresponding look up table values and the pixels of the first and second or fourth image; and
for each pixel of the first and either third or fifth images:
for the second beta-carotene concentration, the first melanin concentration and first melanin blend-type fraction, determining a first dermal haemoglobin concentration, and first epidermal haemoglobin concentration based on respective dermal haemoglobin concentrations, and epidermal haemoglobin concentrations that minimise a distance metric in colour space between the corresponding look up table values and the pixels of the first and third or fifth image.

11. The method of claim 1 further comprising:
wherein the inputs further comprise a sixth RGB or greyscale image which has the same field of view and contents as the first image, the sixth image corresponding to a sixth visible spectrum illumination condition which comprises a fifth narrowband illumination condition;
the method further comprising:
receiving a seven-dimensional look up table corresponding to narrowband red illumination comprising RGB values or greyscale values as a function of the melanin concentration, the melanin blend-type fraction, the dermal haemoglobin concentration, the epidermal haemoglobin concentration, the beta-carotene concentration, the epidermal water concentration and the dermal water concentration;
using the estimated parameters for the melanin concentration, the melanin blend-type fraction, the dermal haemoglobin concentration, the epidermal haemoglobin concentration and the beta-carotene concentration; and
for each pixel of the sixth image, determining an epidermal water concentration and a dermal water concentration that minimise a distance metric in colour space between the corresponding look up table values and the pixels of the sixth image.

12. (canceled)

13. The method of claim 1 wherein processing the inputs to fit the parameter maps comprises:
mapping the first image to the model parameters using a first neural network.

14. (canceled)

15. The method of claim 13, wherein the first neural network is trained on RGB values of the parameter maps, and wherein the ground truth is the corresponding melanin concentration, a melanin blend-type fraction, a dermal haemoglobin concentration, an epidermal haemoglobin concentration and a beta-carotene concentration parameters.

16. (canceled)

17. A method of obtaining images for fitting a model, comprising capturing a first RGB image of human skin using a visible spectrum broadband illumination condition, a second RGB image using a visible spectrum broadband illumination condition and an illumination condition between 450 and 495 nanometres, and capturing a third RGB image of human skin using a visible spectrum broadband illumination condition and an illumination condition between 500 and 565 nanometres.

18. A method of estimating spectral response functions for human skin, comprising:
receiving parameter maps for a hyperspectral bidirectional scattering surface reflectance distribution function skin appearance model, the parameter maps comprising a melanin concentration, a melanin blend-type fraction, a dermal haemoglobin concentration, an epidermal haemoglobin concentration and a beta-carotene concentration;
for each pixel of the parameter maps, using the parameter map values to estimate a skin spectral response function for a wavelength range spanning from near infrared to ultraviolet; and
storing and/or outputting the skin spectral response functions estimated for each pixel.

19. The method of claim 18, wherein each skin spectral response function is calculated for each of a plurality of evenly spaced wavelengths spanning the range; or each skin spectral response function is expressed as a closed function of the absorbances of the parameters.

20. (canceled)

21. The method of claim 18, wherein each skin spectral response function may be calculated using principal components of hyperspectral skin reflectance data.

22. The method of claim 21 wherein the principal components are calculated by applying a principal components analysis to a training set of hyperspectral skin reflectance data.

23. The method of claim 18, wherein each skin spectral response function is determined using a neural network trained on a principal component representation where the ground truth is the skin spectral response represented in terms of principal components, wherein the network maps input parameters comprising melanin concentration, a melanin blend-type fraction, a dermal haemoglobin concentration, an epidermal haemoglobin concentration and a beta-carotene concentration to a principal component representation of skin spectral response.

24. (canceled)

25. The method of claim 18 comprising:
rendering an output image using the spectral response functions.
